(19) United States
(12) Patent Application Publication
(10) Pub. No.: US 2017/0344704 A1
(43) Pub. Date: Nov. 30, 2017

(54) COMPUTER ASSISTED SYSTEMS AND METHODS FOR ACQUISITION AND PROCESSING OF MEDICAL HISTORY

(71) Applicant: Xue CHU, San Francisco, CA (US)

(72) Inventor: Xue CHU, San Francisco, CA (US)

(21) Appl. No.: 15/605,187

(22) Filed: May 25, 2017

Related U.S. Application Data
(60) Provisional application No. 62/341,832, filed on May 26, 2016.

(51) Int. Cl. G06F 19/00; G06F 17/22; G06F 3/16

(52) U.S. Cl. CPC G06F 19/322; G06F 19/325; G06F 3/167; G06F 17/2264; G06F 19/363

(57) ABSTRACT

A computer assisted system and method for acquisition and processing of medical history, includes facilitating, by a processor, receipt of medical history data corresponding to a patient in a structured format. The history data includes information corresponding to health condition of the patient. The method includes providing a quick response code corresponding to the medical history data of the patient to a physician system. Further, the method includes facilitating, by the processor, receipt of physician observation data from the physician system in response to the quick response code. The physician observation data is appended to the medical history data. The method includes transforming, by the processor, the medical history data of the patient and the physician observation data into a natural language format. Furthermore, the method includes storing, by the processor, the medical history data of the patient in the natural language format in an electronic medical record.

### TECHNICAL FIELD

The present disclosure generally relates to medical data and, more specifically, to computer assisted systems and methods for acquisition and processing of patient medical history.

### BACKGROUND TO THE INVENTION

Medical diagnosis of a patient requires a physician to acquire accurate medical history of the patient. The conventional medical diagnosis methods necessitate the physician to manually acquire medical history by questioning the patient and recording responses of the patient. The acquired patient history can be stored in an Electronic Medical Record System (EMR) by clinical workers in natural language, and it includes a lot of personal detail associated with the patient. Natural language understanding is generally considered an artificial intelligence (AI) hard problem. Therefore, processing medical data stored in natural language faces many challenges.

Manually acquiring patient history is time consuming, cumbersome and does not necessitate expertise of the physician. Alternatively, electronic devices can be used to assist the physician for acquiring patient history, wherein the patient can provide responses to a pre-determined questionnaire. However, such electronic device assisted method of acquiring history from a patient in a hospital necessitates electronic devices in hospitals such as computers, to input the answers, which proves to be costly for the hospital. Alternatively, medical history of the patient may be stored in devices associated with the patient, for example, mobile phones. However, the data stored in personal mobile phones or computers are hard to transfer into the physician's EMR due to data security issues. This may require the physician or a trained professional to input medical history of the patient.

Therefore, due to difficulty in processing the stored medical history in form of natural language and other factors, there is a need for an efficient system to acquire and process medical history.

### SUMMARY

Various methods, systems and computer readable mediums for acquisition and processing of medical history are disclosed.

In an embodiment, a method for acquisition and processing of medical history is provided. The method includes facilitating, by a processor, receipt of medical history data corresponding to a patient. The medical history data is obtained in a structured format and comprises information corresponding to health condition of the patient. The method also includes providing, by the processor, a quick response code corresponding to the medical history data of the patient to a physician system. Further, the method includes facilitating, by the processor, receipt of physician observation data from the physician system in response to the quick response code received at the physician system. The physician observation data is appended to the medical history data. The method includes transforming, by the processor, the medical history data of the patient and the physician observation data into a natural language format. Furthermore, the method includes storing, by the processor, the medical history data and the physician observation data in the natural language format in an electronic medical record.

In another embodiment, a system is provided. The system includes a memory to store instructions, and a processor coupled to the memory and configured to execute the stored instructions to cause the system to acquire and process medical history. The system is caused to facilitate receipt of medical history data corresponding to a patient. The medical history data is obtained in a structured format comprising information corresponding to health condition of the patient. Further, the system is caused to provide a quick response code corresponding to the medical history data of the patient to a physician system. The system is further caused to facilitate receipt of physician observation data from the physician system in response to the quick response code received at the physician system. The physician observation data is appended to the medical history data. The system is further caused to transform the medical history data of the patient into a natural language format. Furthermore, the system is caused to store the medical history data of the patient in the natural language format on an electronic medical record.

In another embodiment, a computer assisted history tracking system (CAHTS) for acquisition and processing of medical history, includes a patient CAHTS, a physician CAHTS and a server. The patient CAHTS is accessible to a user device. The patient CAHTS is configured to present questionnaire to a user of the user device in structured format, to collect medical history data based on user's response to the questionnaire in the structured format, and to generate a quick response code corresponding to the medical history data. The physician CAHTS is accessible on a physician device. The physician CAHTS is configured to receive the quick response code corresponding to the medical history data from the patient CAHTS, and append the physician observation data to the medical history data obtained from the quick response code. The server is configured to receive the medical history data appended with the physician observation data, and transform the medical history data appended with the physician observation data into a natural language format. The server is further configured to store the medical history data appended with the physician observation data in the natural language format in an electronic medical record.

Other aspects and example embodiments are provided in the drawings and the detailed description that follows.

### BRIEF DESCRIPTION OF THE FIGURES

The advantages and features of the present disclosure will become better understood with reference to the detailed description taken in conjunction with the accompanying drawings, wherein like elements are identified with like symbols, and in which:

FIG. 1 is a schematic illustration of a hospital environment, wherein various embodiments of the present disclosure can be practiced;

FIG. 2A shows an example flow diagram for acquisition and storing medical history, in accordance with an example scenario;

FIGS. 2B and 2C show an example flow diagram for acquisition and processing medical history, in accordance with an embodiment of the present disclosure;

FIG. 3A illustrates an example flow diagram of a Computer Assisted History Taking System (CAHTS), in accordance with an example scenario;

FIG. 3B illustrates an example flow diagram of a Computer Assisted History Taking System (CAHTS), in accordance with an embodiment of the present disclosure;

FIG. 4A illustrates an example flow diagram for generating natural language based on processed standard medical data, in accordance with an embodiment of the present disclosure;

FIG. 4B illustrates an example flow diagram for acquisition and processing of medical history, in accordance with another embodiment of the present disclosure;

FIG. 4C illustrates an example architecture depicting communication between a physician system and knowledge base, in accordance with an embodiment of the present disclosure;

FIG. 5 is an example of a system for automated acquiring and storage of patient medical history, in accordance with an example embodiment of the present disclosure; and

FIG. 6 is a schematic block diagram of a user device, in accordance with an example embodiment of the present disclosure.

The drawings referred to in this description are not to be understood as being drawn to scale except if specifically noted, and such drawings are only exemplary in nature.

### DETAILED DESCRIPTION

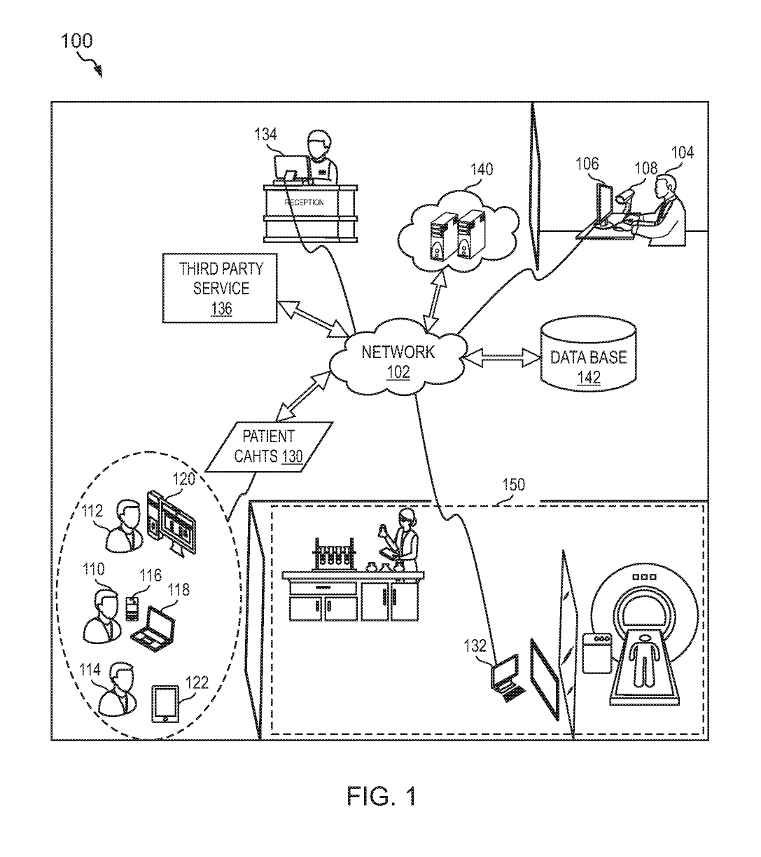

The best and other modes for carrying out the present disclosure are presented in terms of the embodiments, herein depicted with reference to FIGS. 1 to 6. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present disclosure. Further, it is to be understood that the phraseology and terminology employed herein are for the purpose of the description and should not be regarded as limiting. Any heading utilized within this description is for convenience only and has no legal or limiting effect. The terms “a” and “an” herein do not denote a limitation of quantity, but rather denote the presence of at least one of the referenced item.

The term ‘patient history’ used throughout the description includes demographic information of patient, immunization record, vital signs, any possible kind of health issues that may relate to physical health, behavior, mental health, etc., of a patient, allergies, self-reported healthcare condition, diagnostic tests performed for the health issue, physical examination, observation, detected illness, treatment plan, or any other input. Further, the term ‘treatment’ includes any assistance that falls into categories of promotive, preventive, therapeutic, diagnostic, curative, or rehabilitative treatment for the betterment of individuals.

Various embodiments of the present disclosure provide processes, systems and platform that use input data from a user and/or third parties to inform about a patient's history (e.g., mental health) status to a physician. Various embodiments apply algorithms and machine learning techniques on input data and secondary data, created via syntheses and analyses, to derive approximations of symptoms associated with health and illness factors obtained from the patient's history. These symptoms may further be used to aid the physician in diagnosing medical condition associated with the patient, rule out specific medical condition associated with the patient or request further diagnosis for determining medical condition associated with the patient. In some embodiments, the patient's history is stored in Electronic Medical Record (EMR) along with patient details. Alternatively, the patient's history may be stored in a database without any patient details.

The term ‘input data’ used throughout the present description refers to patient history obtained from the user based on demographic information of the patient, healthcare condition status, symptoms input, current concerns, allergies, self-reported health condition, or any other input that can be provided by the patient to aid in diagnosing illness of the patient.

For the purpose of the present disclosure, ‘patient’ and ‘user’ are used interchangeably throughout the present description.

FIG. 1 is a schematic illustration of a hospital environment 100, wherein at least some embodiments of the present disclosure can be practiced. An example representation of the environment 100 is shown depicting a communication network (e.g., a network 102) that connects entities such as a physician 104, a physician Computer Assisted History Taking System (CAHTS) 106, a plurality of users (e.g., users 110, 112 and 114), a patient Computer Assisted History Taking System (CAHTS) 130, a computer system 132, a computer system 134, third party services (e.g., a third party service 136), a server 140 and a database 142. The network 102 may be a centralized network or may include a plurality of sub-networks that may offer a direct or indirect communication between the network components. Examples of the network 102 include, but are not limited to, the Internet, local area network (LAN), wide area network (WAN), wireless, wired, and the like.

The plurality of users 110, 112, 114 (also interchangeably referred to as ‘patients’ or ‘caretakers’, or ‘patient attendants’) may have one or more electronic devices to communicate with other entities of the environment 100 via the network 102. For instance, each of the users 110, 112 and 114 may have a network of devices that can be connected over a home network, LAN, a wireless network, a Bluetooth based network, or such other types of network. For instance, the user 110 has one or more devices, for example a device 116 and a device 118. Similarly, the user 112 and 114 has one or more devices, for example a device 120 and a device 122, respectively. Examples of the devices 116, 118, 120, 122 include, but are not limited to, desktops, laptops, smartphones, tablets, smart watches, and other such data processing devices with communication capability or such devices that can be accessed by any other devices having communication capability.

In an example embodiment, the patient CAHTS 130 includes an application that may be accessed by the plurality of the users 110, 112, 114 on corresponding network devices 116, 118, 120, 122. It is noted that the devices 116, 118, 120, 122 may belong to the hospital and these can be used by the incoming patients or any authorized users. In an example embodiment, at least some of these devices may have an application of CAHTS 130 installed thereupon, so that the CAHTS 130 can be used by the patients or any other users on the devices 116, 118, 120, 122. In case of the devices 116, 118, 120, 122 being personal device of users, users may install the application of the CAHTS 130 on their devices, or may access the CAHTS 130 using a weblink, a prompt, or any similar technology.

In an example embodiment, the application associated with the patient CAHTS 130 presents a questionnaire to record medical condition of the user on respective device of the user. For instance, the questionnaire may include questions to evaluate patient's medical history, which involve symptoms for diagnosis or negative symptoms for differential diagnosis. In an example embodiment, the user (e.g., user 110 associated with device 116) may choose to provide a main complaint as the input data. The questionnaire generated in response includes questions on related symptoms based on the main complaint provided by the patient. For instance, the user (e.g., user 110) can provide input data about patient medical history such as main symptom associated with physical health. The subsequent questions in the questionnaire comprise one or more questions based on symptoms related to the main complain for diagnosing the illness and one or more questions for differential diagnosis. The one or more questions for differential diagnosis in the questionnaire enable in ruling out certain illness. In an example embodiment, patients (e.g., user 112) with reading difficulty may choose to listen to the questionnaire and respond to questions in UI of the user device. The questionnaire generated by the patient CAHTS 130 provides a structured data organization of the patient's medical history. In an example embodiment, the patient CAHTS 130 may include software that generates a Quick Response (QR) code corresponding to the user's response to the questionnaire. The QR code provides data security for the patient history, for example, responses recorded by the user 110 in the device 116. In an embodiment, the patient history in form of QR code may be safely transmitted through the communication network 102 to a device including physician CAHTS 106 to be displayed to the physician 104. It is also to be understood that the patient's medical history is also stored in the server 140 and/or the database 142. In an example embodiment, the questionnaire may additionally be presented to the user in form of audio output, and user voice input maybe recorded as answers to the questions that asked inform of audio.

In some example embodiments, the hospital environment 100 further includes a Quick Response (QR) code scanner 108. The QR code scanner 108 decodes the QR code generated by the patient CAHTS 130. The decoded QR code corresponds to the patient's medical history as recorded by user (e.g., the user 112) in the application provided by the patient CAHTS 130 on the device 120. In an example embodiment, the decoded QR code corresponding to patient's medical history of user (e.g., the user 112) is displayed in the physician CAHTS 106 associated with the physician 104. The physician 104 acquires more specific medical history of the patient (e.g., user 112) based on the patient medical history acquired by the patient CAHTS 130. For instance, the physician 104 may question the patient (e.g., user 112) about persisting symptoms of fever that the patient recorded in the patient CAHTS 130. In an example embodiment, the physician 104 records responses of the patient (e.g., the user 112) in the physician CAHTS 106.

In an example embodiment, the physician 104 may perform further examination of the patient and record observations in the physician CAHTS 106. For example, the physician 104 may physically examine the patient (e.g., the user 112) based on acquired patient history. The physician 104 records observation details corresponding to the patient in the physician CAHTS 106. In some embodiments, the physician 104 may further request diagnostics tests (e.g., in a laboratory facility 150) for the patient and record results of the diagnostic test on the physician CAHTS 106. For instance, the physician may request laboratory tests of blood sample to determine medical condition of the patient (e.g., the user 112). The results of the laboratory tests are recorded on the physician CAHTS 106 automatically from the computer system 132 associated with the laboratory facility 150 through the communication network 102.

In an example embodiment, the physician CAHTS 106 may be configured to process standard data. For instance, the physician CAHTS 106 may process and analyze the responses recorded by the patient for the questionnaire in the patient CAHTS 130. In an example embodiment, the physician CAHTS 106 may assist the physician 104 in diagnosing illness associated with the patient. The physician may use the physician CAHTS 106 to record medical information such as symptoms, signs, diagnosis, medicine side effect and curative effect. For instance, the physician CAHTS 106 may display a list of illness based on the patient history, for example, results of physical examination and diagnostic tests. The physician 104 may select the illness that may be associated with the patient. In an example embodiment, a list of treatment plans corresponding to the illness selected by the physician 104 may be generated by the physician CAHTS 106. The physician 104 may select a treatment plan for the patient from the list of treatment plans and explain the treatment plan to the patient. In an example embodiment, the physician CAHTS 106 may be configured to analyze and classify medical data associated with the patient. The classified medical data may be stored in the database 142 for further analysis that may increase efficiency of classification. In an example embodiment, the computer system 134 may be used to acquire billing information associated with the patient (e.g., user 112). Examples of the computer systems 132 and 134 include, but are not limited to, desktops, laptops, smartphones, tablets, servers, and other such data processing devices with communication capability or such devices that can be accessed by any other devices having communication capability.

In some example embodiments, the server 140 may include one or more processing elements (e.g., computing systems, databases, etc.) to process the information received from the users' network devices 116, 118, 120, 122, the physician CAHTS 106, the patient CAHTS 130, the computer systems 132 and 134 for acquiring and storing medical history associated with the users (e.g., users 110, 112, 114) in the database 142 or in any other memory location accessed by the server 140. In some examples, the server 140 may also receive patient related information from the third party service 136. It is understood that the functionalities of the server 140 can be embodied, at least in part, even in one or more devices amongst the devices 116, 118, 120, 122 or in devices associated with the third party service 136, or the physician CAHTS 106. In such embodiments, the automated acquiring and storage of patient history may be provided locally by the application stored/installed/accessed in the devices 116, 118, 120, 122.

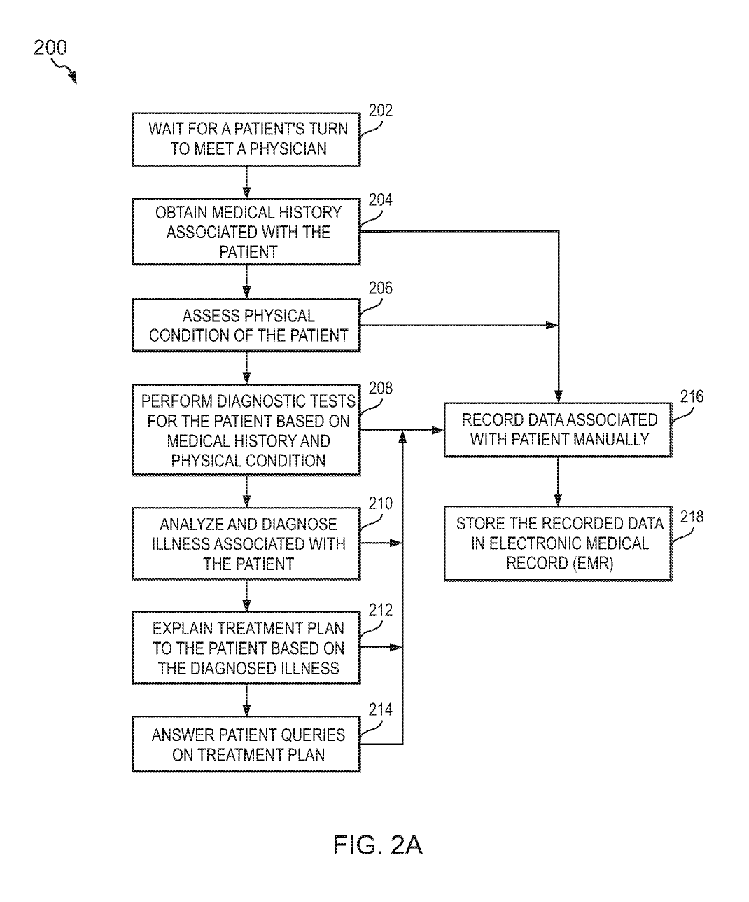

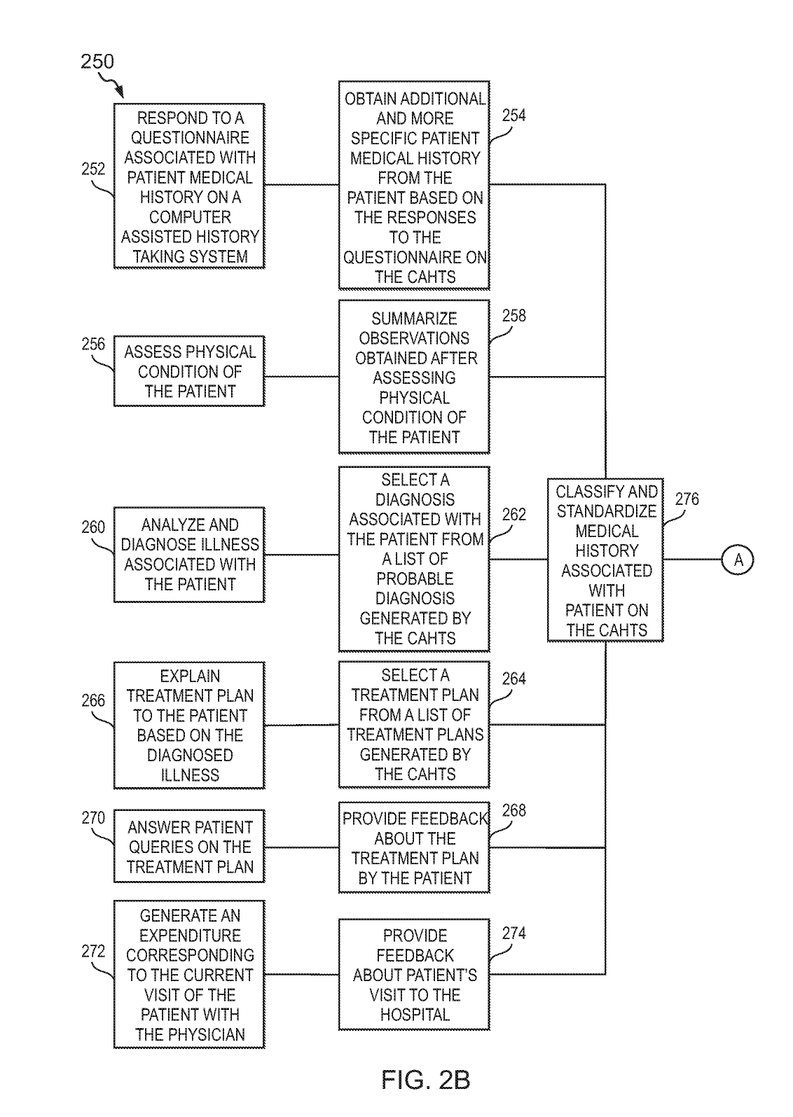

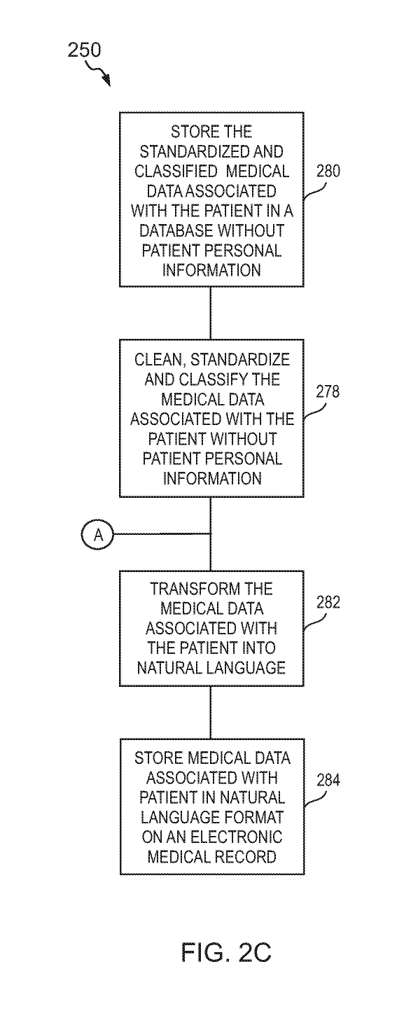

Referring now to FIG. 2A, an example flow diagram of a method 200 for acquisition and storing medical history, is shown in accordance with an example scenario (not in accordance with embodiments of the present disclosure). Block 202 represents waiting for a patient's turn to meet a physician. In an example scenario, if two patients are seated in a waiting room of a hospital (e.g., the environment 100) a patient who enters the hospital has to wait for a time corresponding to consultation time of the two patients with the physician. At block 204, the method 200 includes obtaining medical history associated with the patient by the physician. In an example scenario, the physician questions the patient about presenting medical condition (e.g., main complaint) of the patient and records responses of the patient to obtain medical history of the patient. For example, the physician's questions may include questions based on symptoms, current concerns, allergies and self-reported health condition. At block 206, the method 200 includes assessing physical condition of the patient. In an example scenario, the physician may physically examine the patient based on the medical history provided by the patient to determine illness associated with the patient. At block 208, the method 200 may optionally include performing diagnostic tests for the patient based on medical history and physical condition of the patient. In an example scenario, the physician may request diagnostic tests such as laboratory test of blood sample or Computerised Tomography (CT) scan etc., to be performed on the patient for accurately determining the illness associated with the patient.

At block 210, the method 200 includes analyzing and diagnosing illness associated with the patient. In some examples, the physician diagnoses the illness associated with the patient based on the medical history of the patient. The medical history of the patient includes medical condition disclosed by the patient, physician assessed physical condition and results of diagnostic tests. At block 212, the method 200 includes explaining treatment plan to the patient based on the diagnosed illness. For instance, the physician explains details of surgery and medication for the diagnosed illness based on the medical history of the patient. At block 214, the method 200 includes answering patient queries on the treatment plan. For example, the physician answers patient's concerns on precautions, side effects of surgery and medication.

At block 216, the method 200 includes recording data associated with patient manually. In an example scenario, the physician manually records medical history, physical condition, diagnostic tests, diagnosed illness, treatment plan and patient queries associated with the patient in a health record manually. At block 218, the method 200 includes storing recorded data in an Electronic Medical Record (EMR). It is noted that any trained professional may record the data associated with the patient history in the EMR.

It is noted that the example scenario, where the embodiments of the present invention are not used, the patients and physicians face some challenges in terms of unavailability of structured format and manual acquisition of patient history and diagnosis by questioning the patient and recording responses of the patient. Thereafter, the patient history is stored in the EMR system by clinical workers manually in natural language including a lot of personal detail associated with the patient. Such process is quire labor intensive, and accuracy may also be compromised. Hence, various embodiments of the present invention described with reference to FIGS. 2B-2C to 6 obviate the above drawbacks in addition to providing other existing benefits.

FIGS. 2B and 2C illustrate an example flow diagram for acquisition and processing medical history, in accordance with an embodiment of the present disclosure. At 252, the method 250 includes responding to a questionnaire associated with patient's medical history on a Computer Assisted History Taking System (CAHTS). In an example embodiment, the CAHTS may include application software that may be accessed by the patient or a caretaker associated with the patient on a device associated with the patient, for example, smartphone. For instance, the application may include a questionnaire to determine medical condition associated with the patient. The user can chose to provide a main complaint as the input data in the questionnaire. The questionnaire generated by the CAHTS in response to the main complaint may use multiple choice questions to collect medical history associated with the patient. The CAHTS searches a database (e.g., database 142) for symptoms related to the main complaint and generates a questionnaire in response to the main complaint that includes questions based on related symptoms for evaluating health condition of the patient and differential diagnosis for ruling out certain illness. In an example embodiment, the questionnaire may be adaptive and is arranged such that a current question presented to the patient is based on patient's response to previous questions. The questionnaire provided by the application aids the physician to automatically acquire patient's medical history. The patient or the care-taker associated with the patient may answer the questionnaire in a waiting room while the patient waits for a turn to meet the physician. In an example embodiment, the responses recorded by the patient for the questionnaire are standard and structural. For example, the questionnaire comprises multiple choice questions so that the response is standard and structural. An example of the CAHTS may be the patient CAHTS 130 described with reference to FIG. 1. In an example embodiment, the answers of the questionnaire are encoded in form of QR code in the user device and sent to the CAHTS. The automated acquisition and storing of patient's medical history on the CAHTS is further described with reference to FIG. 1.

At 254, the method 250 includes obtaining additional and more specific patient medical history from the patient based on the responses to the questionnaire on the CAHTS. For instance, the physician accesses the response provided by the patient in the CAHTS (e.g., by decoding the QR code with the help of QR scanner), and further questions the patient based on the responses, and further records the responses on the CAHTS (e.g., the physician CAHTS 106). In an example embodiment, the CAHTS 106 analyzes the responses provided by the patient to the questionnaire and aids the physician in diagnosing illness associated with the patient. For instance, the CAHTS 106 classifies the medical history associated with the patient based on the responses provided by the patient and generates another questionnaire that may be accessed by the physician to get additional details associated with the patient based on the classification. For example, the patient medical history obtained from the response of the patient to the questionnaire may indicate symptoms such as dizziness and fainting. The questionnaire generated by the CAHTS 106 after analyzing and classifying patient's medical history may include questions about frequencies of the symptoms and other health issues associated with the symptoms. In an example embodiment, the physician records medical information such as symptoms, signs, diagnosis, medicine side effect and curative effect by responding to the questionnaire generated by the CAHTS 106 that may include multiple choice questions.

At 256, the method 250 includes assessing physical condition of the patient. In an example embodiment, physical condition may include physical examination by the physician and performing diagnostic tests. The patient may be physically examined by the physician based on the medical history provided by the patient to determine physical condition of the patient. For instance, the physician may examine ear, nose and throat of a patient presenting with symptoms of influenza as recorded in the medical history of the patient. Additionally, the physician may request to perform diagnostic tests for the patient based on medical history and physical condition. For instance, the physician requests laboratory tests on blood samples of the patient based on medical history and physical examination to determine the illness associated with the patient. At 258, the method 250 includes summarizing observations obtained after assessing physical condition of the patient. For instance, the physician may summarize the results of diagnostics tests, for example, radiology test results and store the results in the CAHTS.

At block 260, the method 250 includes analyzing and diagnosing illness associated with the patient. In an example embodiment, the CAHTS assists the physician in diagnosing the illness associated with the patient based on classification of the medical history of the patient. For instance, the questionnaire generated by the CAHTS may aid the physician to make clinical decisions through diagnostic algorithm or using decision tree classifier. At block 262, the method 250 includes selecting a diagnosis associated with the patient from a list of probable diagnosis generated by the CAHTS. In an example embodiment, the CAHTS classifies medical history associated with the patient based on responses to the questionnaire and generates the list of probable diagnosis. The physician may select a diagnosis corresponding to the illness associated with the patient. For instance, the questionnaire generated by the CAHTS may aid the physician to make clinical decisions through diagnostic algorithm or using decision tree classifier. The medical history corresponding to the patient may be classified based on the questionnaire that is classified and the illness associated with the patient may be diagnosed based on classification.

At block 264 the method 250 includes selecting a treatment plan from a list of treatment plans generated by the CAHTS. In an example embodiment, the CAHTS may be configured to classify the diagnosis based on the patient history and generate the list of treatment plans that may suit the patient. For instance, the CAHTS may perform a search in the database (e.g., database 142) that includes classified data corresponding to medical history obtained from a plurality of patients, for generating list of treatment plans. The physician may select the treatment plan from the list of treatment plans generated by the CAHTS. At block 266, the method 250 includes explaining treatment plan to the patient based on the diagnosed illness. For instance, the physician explains details of diagnosed illness, prescribed medications, side effects, precautions to be taken by the patient.

At block 268, the method 250 includes providing feedback about the treatment plan by the patient. In an example embodiment, the patient feedback may include queries pertaining to the treatment plan. For instance, the patient may use the CAHTS to communicate with the physician about possible side effects of a prescribed medication. At block 270, the method 250 includes answering patient queries on the treatment plan. For example, the physician answers patient's concerns on precautions, side effects of medication, allergies and other health related problems.

At block 272, the method 250 optionally includes the generating an expenditure corresponding to the current visit of the patient with the physician. For example, billing information associated with the patient, such as, laboratory tests, radiology and physician consultation is generated. At block 274, the method 250 includes providing feedback about patient's visit to the hospital. For instance, the patient may provide feedback based on patient's experience in the hospital, for example, healthcare facilities. In another embodiment, the user can provide feedback about treatment plan during a review visit to the hospital. For instance, the user can respond to the questionnaire about any side effects of treatment plan, time taken for recovery or report about improvements or deterioration in health condition of the patient. The feedback obtained from the patient is used to update the database (e.g., database 142) for analyzing and improving the treatment and diagnosis. For example, machine learning algorithms can be implemented in the database to reinforce learning and help provide more related diagnosis and treatment plans.

At block 276, the method 250 includes classifying and standardizing medical history associated with patient on the CAHTS. It should be noted that recording of the medical data, classifying and standardizing of medical history may be a continuous process, and as shown in the illustrated example of FIG. 2B, inputs from blocks 254, 258, 262, 264, 268 and 274 are recorded and processed by the CAHTS (patient CAHTS 130 as well as the physician CAHTS 106). The processing by CAHTS includes analyzing and classifying the inputs from the blocks 254, 258, 262, 264, 268 and 274. In an example embodiment, the CAHTS (e.g., physician CAHTS 106) receives medical data corresponding to the patient. The medical data comprises responses of patient to questionnaire associated with patient's medical history, observation of physician about physical condition of the patient, diagnostics tests performed, results of diagnostic tests, analysis of patient's health, diagnosed illness of patient, treatment plan for the diagnosed illness and patient queries. In an example embodiment, the CAHTS receives the medical data through a communication network, such as, for example, the network 102.

As shown in FIG. 2C, at block 278, the method 250 includes cleaning, standardizing and classifying the medical data associated with the patient without patient personal information. In an example embodiment, the CAHTS classifies the medical data associated with the patient. For instance, CAHTS generates questionnaire that include multiple choice questions to record medical information. The questionnaire is standard and structural, for example, questions are generated based on responses to previous questions, such that the choice is standard and structural. The medical data is classified based on the response to the questionnaire that includes questions that are classified. In an example embodiment, the medical data in the physician's CAHTS may be transformed to structured data without patient personal information, such as, for example, patient name, billing information, contact information, and the like. At block 280, the method 250 includes storing the standardized and classified medical data associated with the patient in a database without patient personal information, for example, the database 142 (shown in FIG. 1). In an example embodiment, the medical data may be stored in a digital format in the database. The medical data stored in the database may be used to study possible trends and population-based studies of medical records. Alternatively or additionally, the medical record stored in the database may be used to update questionnaire.

At block 282, the method 250 includes transforming the medical data associated with the patient into natural language. In an example embodiment, the CAHTS may have associated processor that may be configured to generate natural language from complex structured data and unstructured data corresponding to the medical data of the patient in the CAHTS. Structured data includes fixed responses provided by the patient to the questionnaire and unstructured data includes the physician's observation of physical health of patient, patient queries, and the like. At 284, the method 250 includes storing medical data associated with patient in natural language format on an Electronic medical record (EMR). In an example embodiment, EMR includes personal information and medical data associated with the patient. The EMR stores medical data associated with the patient across time. In an example, the EMR may be stored in a database such as the database 142.

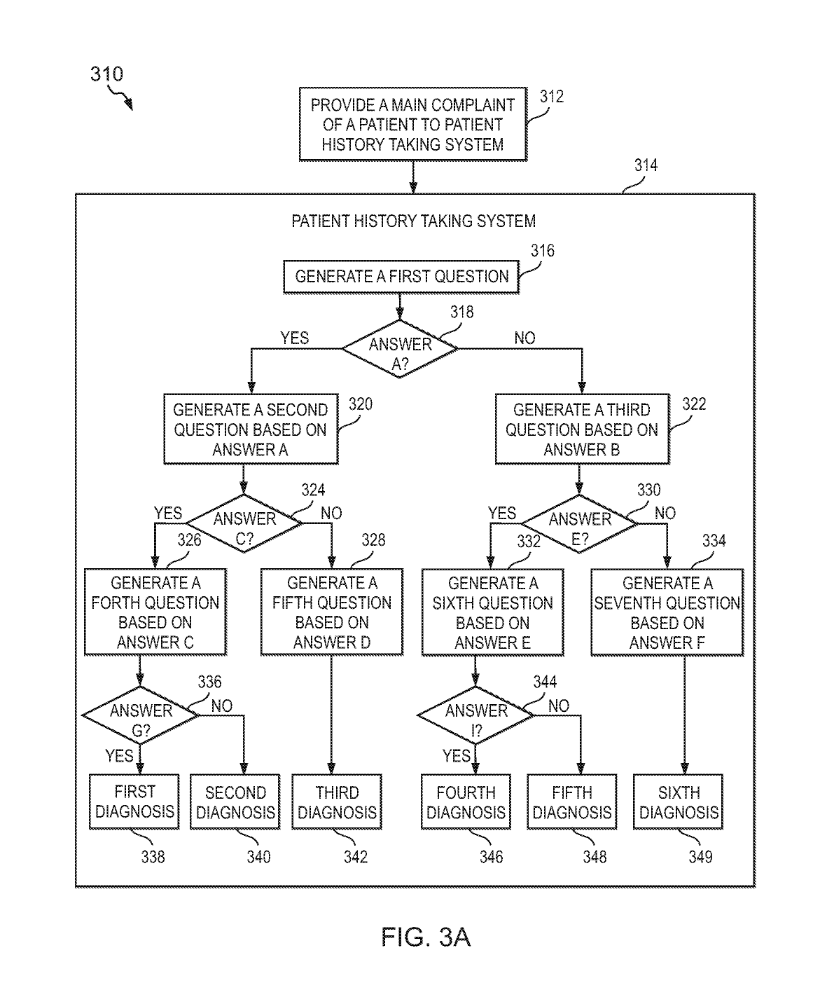

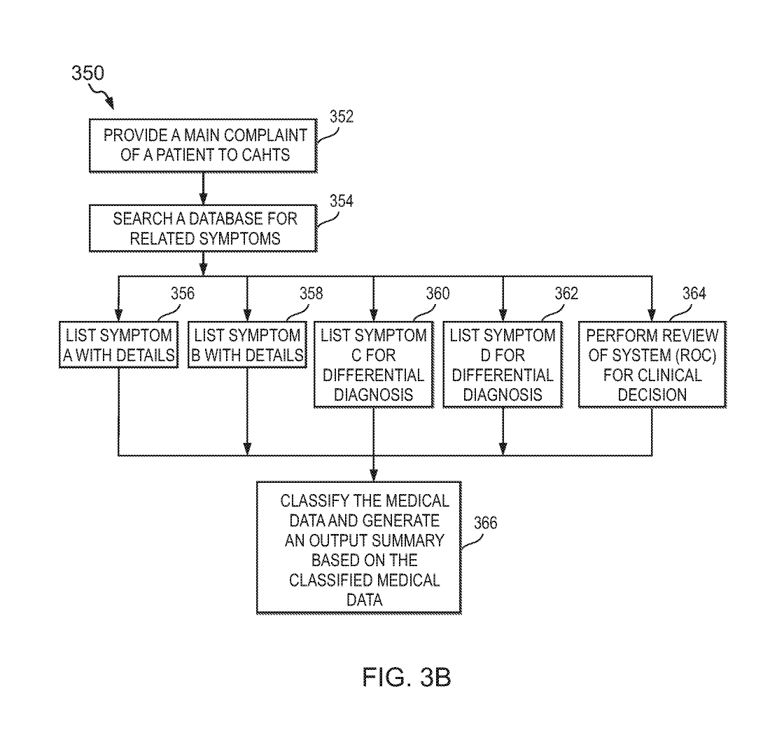

FIG. 3A illustrates an example flow diagram of a method 310 of a patient history taking system, in accordance with an example scenario (not in accordance with embodiments of the present disclosure). At block 312, the method 310 includes providing a main complaint of a patient to the patient history taking system. For instance, the main complaint may correspond to persisting symptoms associated with medical condition of the patient. At 314, the method 310 includes generating a list of diagnosis of the patient based on the patient's response to a questionnaire. In an example, the patient history taking system may be configured to generate list of diagnosis associated with medical condition of the patient based on a questionnaire generated by the patient history taking system. In this example scenario, the questionnaire may include multiple choice questions and the patient may choose an answer associated with the medical condition of the patient.

At 316, the method 310 includes generating a first question by the patient history taking system. The first question may be based on the main complaint provided by the patient. For instance, if the main complaint provided by the patient is fever, the first question may be based on symptom associated with fever, for example, if patient has symptoms of throat infection. At 318, it is determined if the patient has selected answer A. For instance, first question based on the main complaint may include yes-no answer, such as, for example, yes answer corresponding to answer A and no answer corresponding to answer B. In an example, if the patient has selected answer A (yes), the patient history taking system may be configured to generate a second question based on answer A (see, 320), for example, question based on nasal congestion. Further, if the patient has selected answer B, the patient history taking system may generate a third question based on answer B at 322. For instance, if the patient has selected answer B (corresponds to no), the patient history taking system generates question (the third question) based on symptoms of vomiting.

At 324, the method 310 includes determining if the patient has selected answer C. If the patient has selected answer C, at 326, a fourth question may be generated based on answer C, otherwise, the patient history taking system generates a fifth question based on answer D, at 328.

At 330, it is determined if the patient has selected answer E. In an example embodiment, if the patient has selected answer E, the CAHTS may be configured to generate a sixth question based on answer E (see, 332). Further, if the patient has selected answer F, the patient history taking system may generate a seventh question based on answer F at 334.

At 336, it is determined if the patient has selected answer G. In an example embodiment, if the patient has selected answer G, the patient history taking system may be configured to generate a first diagnosis based on answer G (see, 338). Further, if the patient has selected answer H, the patient history taking system may generate a second diagnosis based on answer H at 340. At 342, the method 310 includes generating a third diagnosis based on answer provided by the patient for the fifth question for differential diagnosis. At 344, the method 310 includes determining if the patient has selected answer I. If the patient has selected answer I, at 346, a fourth diagnosis may be generated based on answer I, otherwise, the patient history taking system generates a fifth diagnosis based on answer J, at 348. At 349, the method 310 includes listing a sixth diagnosis. The sixth diagnosis may be based on the patient's response to the seventh question for differential diagnosis of illness associated with the patient.

It would be apparent to those ordinarily skilled in the art that questionnaire followed in the conventional patient history taking systems of FIG. 3A is too long and it may require a long time for acquiring sufficient data about patient's medical history. Moreover, patients with no prior knowledge about healthcare find it hard to answer complicated questions, such as, for example, past diagnosis and treatment associated with the past diagnosis.

Various embodiments of the present disclosure offer systems for acquisition and processing of medical history that present simple and structured forms of questions before the patient via the patient CAHTS as explained in FIG. 3B. The structured set of questions is focused on symptoms, differential symptoms and curative effect or side reactions that are more comfortable and familiar by the patients to provide information.

FIG. 3B illustrates an example flow diagram of a method 350 of a Computer Assisted History Taking System (CAHTS), in accordance with an embodiment of the present disclosure. At block 352, the method 350 includes providing a main complaint associated with a patient to a CAHTS (e.g., to a patient CAHTS 130). In an example embodiment, the main complaint may correspond to persisting symptoms associated with a medical condition of the patient or changes in physical condition. At block 354, the method 350 includes searching a database (e.g., database 142) for related symptoms. For instance, the patient presenting with main complaint of fever may also have related symptoms such as, for example, nausea, vomiting, and dizziness. In an example embodiment, the CAHTS system searches the database, for example, the database 142 (see FIG. 1) associated with CAHTS system to generate a list of symptoms associated with the main complaint. The database includes standardized and classified medical data associated with plurality of patients.

At block 356 and block 358, the method 350 includes listing a first symptom (symptom A) and a second symptom (symptom B) with details. In an example embodiment, the CAHTS generates the first symptom and the second symptom that may be associated with the main complaint of the patient based on search operation performed in the database. In an example embodiment, the search operation may be performed by an expert system in the database based on possible trends and population-based studies of medical records.

At block 360 and block 362, the method 350 includes listing a third symptom (symptom C) and a fourth symptom (symptom D) for differential diagnosis of the patient. For instance, the CAHTS system generates the third symptom and the fourth symptom to distinguish a particular disease or medical condition from others that present similar symptoms. For example, the patient presenting with main complaint of fever may be diagnosed with illness such as, for example, viral infection, jaundice or typhoid. The third symptom and the fourth symptom help distinguish the illness associated with the patient history. At block 364, the method 350 includes performing review of system for clinical decision making. In an example embodiment, review of system generates a ROC curve that allows diagnostic tests to be compared over a variety of cutoff points. The ROC curve may be used to determine illness associated with the patient or screen the patient for illness. In an example, a diagnostic test designed to confirm an illness associated with the patient may have a cutoff point with greater specificity and lower sensitivity. Alternatively, if a diagnostic test is designed to screen for an illness, a cutoff point with greater sensitivity and lower specificity is selected.

At block 366, the method 350 includes classifying the medical data and generating an output summary based on the classified medical data. In an example embodiment, the CAHTS classifies data based on responses of the patient to the symptoms listed in blocks 356, 358, 360, 362 and 364. For instance, CAHTS displays list of symptoms and symptoms for differential diagnosis. The physician questions the patient about the list of symptoms and symptoms for differential diagnosis. In an example embodiment, the CAHTS system generates the output summary based on the blocks 356, 358, 360, 362 and 364. The output summary may correspond to diagnose illness or medical condition of the patient based on the first symptom, second symptom, symptoms listed for differential diagnosis and the review of symptoms. In an example embodiment, the medical data associated with the patient is structural and classified based on systematized nomenclature of medicine.

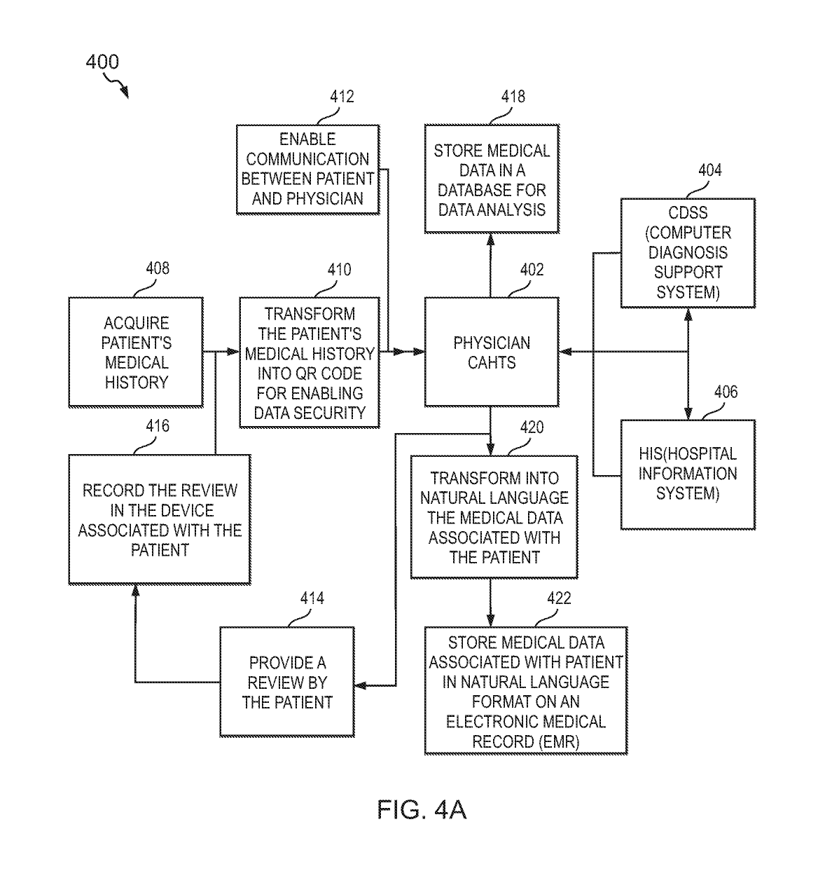

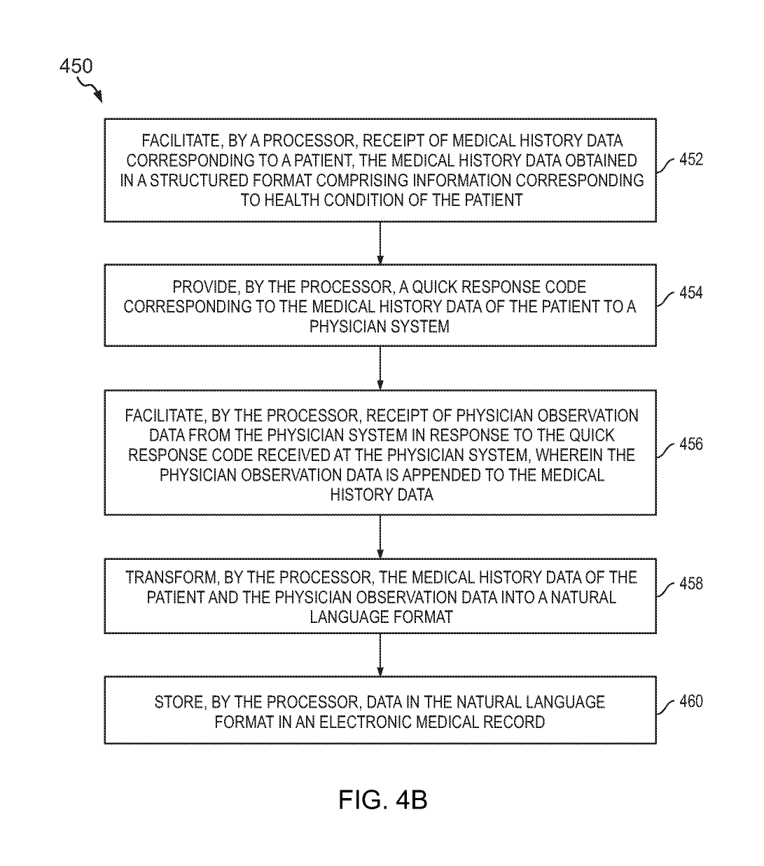

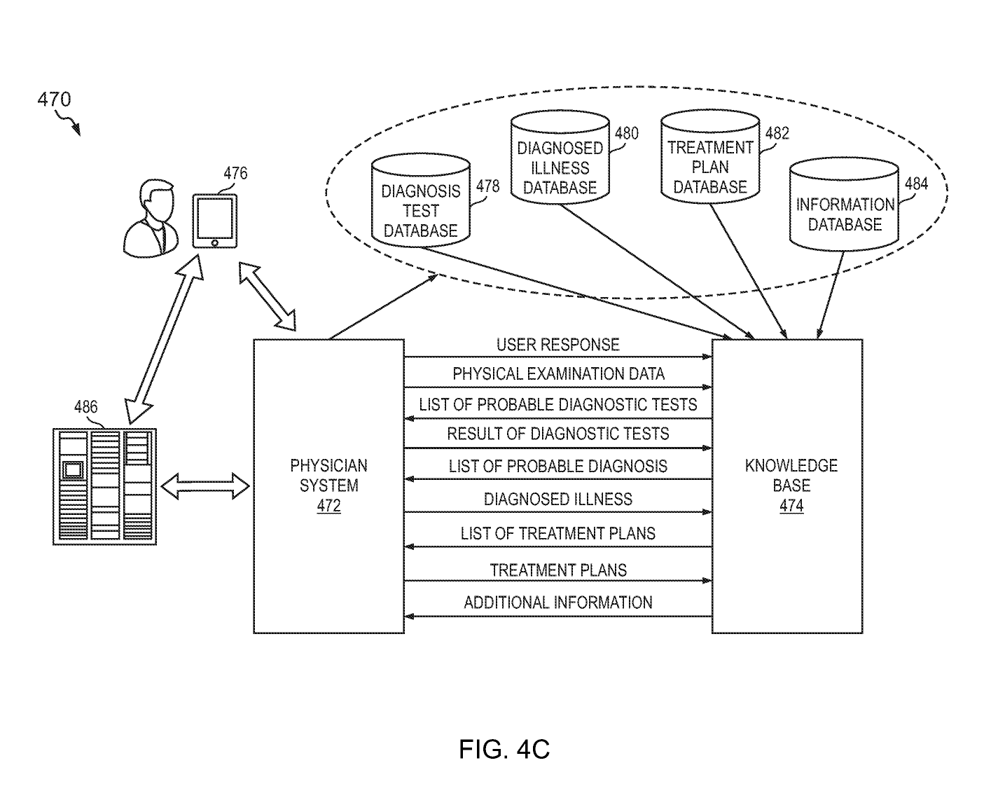

FIG. 4A is an example flow diagram of a method 400 for generating natural language corresponding to medical data of patient based on processed standard medical data, in accordance with an embodiment of the present disclosure. An example flow diagram of the method 400 is shown depicting communication between entities such as a physician CAHTS 402, a Computer Diagnosis Support System (CDSS) 404 and a Hospital Information System (HIS) 406. In an example embodiment, the physician CAHTS 402 along with the CDSS 404 and the HIS 406 assist a physician in diagnosing illness associated with the patient. The physician CAHTS 402 may include software for recording and processing medical data associated with the patient. In an example embodiment, the physician may additionally record details associated with a patient such as, for example, observation of physician about physical condition of the patient, diagnostics tests performed, results of diagnostic tests, analysis of patient's health, diagnosed illness of patient, treatment plan for the diagnosed illness and patient queries. Acquiring of the medical data associated with the patient is described with reference to FIG. 1.

In an example embodiment, the CDSS 404 may be communicably coupled to the physician CAHTS 402 and may be configured to assist a physician in decision making of a patient's medical condition. For instance, the CDSS 404 assists the physician by providing clinical advice based on patient's medical history. For example, CDSS 404 may generate a list of laboratory tests to be performed on the patient for diagnosing illness associated with the patient. In an example embodiment, the physician CAHTS 402 interacts with the CDSS 404 that assists the physician for analyzing and diagnosing illness associated with the patient. For example, the CDSS 404 may generate a list of symptoms associated with main complaint of the patients for differential diagnosis of the illness associated with the patient. Additionally, the CDSS 404 may provide suggestions for treatment plan. In an example embodiment, CDSS 404 may include software designed to logically reason or a combination of hardware and software. Examples of CDSS 404 may include but not limited to expert systems, neural networks and knowledge base systems.

In an example embodiment, the HIS 406, communicably coupled to the physician CAHTS 402 may be configured to manage data associated with hospital. For instance, the HIS 406 manages entities of hospital data, such as, for example, patients medical history, results of physical examination of the physician, laboratory test results, treatment plan, prescriptions, surgeries, billing data and personal data associated with patient. In an example embodiment, the HIS 406 may include one or more software components to manage each entity of the HIS 406. For instance, a software component may be designed to manage billing data associated with the patient and another software component may be designed to manage laboratory results.

At 408, the method 400 includes acquiring patient's medical history. In an example embodiment, the patient's medical history may be obtained using a CAHTS, for example, patient CAHTS 130. In an example embodiment, the CAHTS may include an application that may be accessed on a device associated with the patient. For instance, the application may generate a questionnaire based on main symptom provided by the patient. Acquiring of the patient's medical history is further described with reference to FIG. 1.

At 410, the method 400 includes transforming the patient's medical history into QR code for enabling data security. In an example embodiment, the CAHTS configured to acquire patient's medical history may include software that generates a Quick Response (QR) code corresponding to the patient's medical history as recorded by the CAHTS. For instance, the patient's response to the questionnaire generated by the CAHTS is converted to QR code to provide data security for the patient history. In an example embodiment, the QR code may be transmitted through a communication network to the physician CAHTS 402. The physician CAHTS 402 may include a QR code scanner to decode the QR code. The communication between patient and physician is shown by block 412. In an example embodiment, the patient may communicate remotely to the physician (physician CAHTS 402) via email. For example, the communication may be based on patient queries about the treatment plan or side effects of medication. Alternatively, any other mode of communication may be used for communication between patient and physician, such as, for example, instant messaging, chat, social networking. In an example embodiment, the communication between the physician and the patient may be stored in the physician CAHTS 402.

At 414, the method 400 includes providing a review by the patient. In an example embodiment, the patient may provide feedback about the treatment plan. The patient feedback may include queries pertaining to the treatment plan. For instance, the patient may use the CAHTS to communicate with the physician about possible side effects of a prescribed medication. Additionally, the patient may provide feedback about healthcare facilities in the hospital. At 416, the patient may record the review in the device associated with the patient. In an example embodiment, the recorded review may be transformed to QR code and transmitted over a network, for example, the communication network 102, to the physician CAHTS 402 (see, 410).

At 418, the method 400 includes storing medical data in a database for data analysis without patient personal information. In an example embodiment, the medical data corresponding to the patient's medical in the physician CAHTS 402 may be summarized and standardized for storing in the database. For instance, medical data associated with the patient, such as, main complaint, related symptoms, results of physical examination, observations by the physician, laboratory test results, diagnoses of illness based on medical data and treatment plan may be stored in database without personal information of the patient. In an example embodiment, medical data stored in the database may be used to study possible trends and population-based studies of medical records. The medical data in the database is used for reinforced learning using machine learning methods to improve diagnosis for providing more related diagnosis of illness and treatment plans. Further, feedback acquired from the patient after treatment is used to analyze outcome of treatment, such as, improvement/deterioration in symptoms and side effects of treatment.

At 420, the method 400 includes transforming the medical data associated with the patient into natural language. In an example embodiment, the physician CAHTS 402 may include a processor that may be configured to generate natural language from complex structured data and unstructured data corresponding to the medical data of the patient in the physician CAHTS 402. Transforming the medical data associated with the patient into natural language is further explained with reference to FIG. 2B. At 422, the method 400 includes storing medical data associated with patient in natural language format on an Electronic medical record (EMR). In an example embodiment, EMR includes personal information and medical data associated with the patient. The EMR stores medical data associated with the patient across time.

Referring now to FIG. 4B, an example flow diagram of a method 450 for acquisition and processing of medical history is illustrated in accordance with an embodiment of the present invention.

At 452, the method 450 includes facilitating, by a processor, receipt of medical history data corresponding to a patient. In an embodiment, the medical history data is obtained in a structured format comprising information corresponding to health condition of the patient. For instance, the medical history data of the patient is obtained using a questionnaire provided on a user device associated with the patient. The patient or user associated with the patient records user responses corresponding to questions in the questionnaire. The user associated with the user device responds to the questionnaire in which subsequent questions to the user are based on a main complain provided by the user For example, the questionnaire may comprise questions based on the main complaint for symptom diagnosis or differential diagnosis to rule out specific illness. The questionnaire can be accessed on an application provided on the user device. The application can be provided by a server, such as, the patient CAHTS 130 (shown in FIG. 1). The structured format of obtaining information corresponding to health condition of the patient using a questionnaire has been explained with reference to FIG. 3B.

At 454, the method 454 includes providing, by the processor, a quick response (QR) code corresponding to the medical history data of the patient to a physician system. The user responses of the patient that correspond to medical history data as recorded on the user device of the patient is transformed into QR code for transmission to the physician system over a network. In an example embodiment, the processor includes software that generates the QR code corresponding to the user responses to the questionnaire.

At 456, the method 450 includes facilitating, by the processor, receipt of physician observation data from the physician system in response to the quick response code received at the physician system. The physician observation data is appended to the medical history data. The physician observation data includes physical examination data, a diagnostic test data, the diagnosed illness and the at least one treatment plan for the diagnosed illness. For instance, a QR code scanner (present in the physician system) decodes the QR code generated by the processor and displays medical history data corresponding to the patient (user responses to the questionnaire) on the physician system. The physician (accessing the physician system) acquires more specific medical history data of the patient based on the user responses to the questionnaire and records responses of the patient in the physician system. Further, the physician records information corresponding to physical examination of the patient on the physician system. The physician system also acquires results of diagnostic tests, diagnosed illness and treatment plans corresponding to the patient. The physician system aids the physician by providing list of probable diagnostic tests, list of probable diagnosis and list of treatment plans. The physician selects at least one option from the list provided by the physician system.

At 458, the method 450 includes transforming, by the processor, the medical history data of the patient into a natural language format. The processor is configured to generate natural language from complex structured data and unstructured data corresponding to the medical history data of the patient in the physician system. Transforming into natural language the medical data associated with the patient is further explained with reference to FIG. 2B.

At 460, the method 450 includes storing, by the processor, the medical history data of the patient in the natural language format on an electronic medical record. The EMR is configured to store personal information and medical history data associated with the patient across time.

Referring now to FIG. 4C, an example signal flow diagram 470 showing communication between a physician system 472 and knowledge base 474 is illustrated in accordance with an example embodiment. The knowledge base 474 is shown as a single unit for description purposes. However, the knowledge base 474 may collectively include information from one or more databases based on medical history data of a plurality of patients. The medical history data obtained from the plurality of patients are classified based on diagnosis tests, diagnosed illness and treatment plans and stored in a single database. Alternatively, the classified information related to patient medical history is distributed and stored in multiple databases.

In an embodiment, a user device 476 associated with a patient requests the server system 486 and/or the physician system 472 to provide an instance of an application for recording medical history data (i.e. a patient CAHTS application) of the patient. The application when installed on the user device 476 provides a questionnaire for recording medical history data of the patient in a structured way. The questionnaire comprises questions for symptom diagnosis and determining negative symptoms for differential diagnosis. Acquiring medical history data using the questionnaire is further explained with reference to FIG. 3B. This step will be optional if the user device 476 belongs to the healthcare facility itself, as the patient CAHTS application is already installed on such user device 476.

The physician system 472 is coupled with the knowledge base 474 and is configured to constantly interact with the knowledge base 474. The physician system 472 is configured to compare information related to the patient to a plurality of patterns in the knowledge base 474. The plurality of patterns in the knowledge base 474 corresponds to medical history data obtained from the plurality of patients over time (historical data). The knowledge base 474 analyses and compares the information to provide suggestions for aiding a physician using the physician system 472. In an embodiment, the knowledge base 474 aggregates historical data from multiple samples obtained from multiple databases. The knowledge base 474 is coupled to one or more databases, such as, a diagnosis test database 478, a diagnosed illness database 480, a treatment plan database 482 and an information database 484. The knowledge base 474 includes one or more classifiers for classifying the information related to the patient and providing suggestion based on historical data. It must be noted that the classifier can either be statistical classifier such as, Gaussian mixture model or the classifier can be modelled using artificial neural networks and fuzzy logic.

As shown in FIG. 4C, the physician system 472 receives user response in form of QR code and the physician system 472 decodes the QR code to acquire medical history data in structured form as provided by the user in the user device 476. The physician acquires more specific information from the patient and performs physical examination of the patient based on the user responses to the questionnaire. The user responses and the physical examination data are provided to the knowledge base 474. The knowledge base 474 compares the user responses and physical examination data with the plurality of patterns in the knowledge base 474 to generate a list of probable diagnosis tests to be performed on the patient based on historical data. The list of probable diagnosis tests are displayed to the physician on the physician system 472. The physician selects at least one diagnostic test to be performed on the patient. The results of the diagnostic tests are fed to the physician system 472 automatically from diagnostic services. The results of the diagnostics tests are again compared with the one or more patterns in the knowledge base 474 to generate a list of probable diagnosis based on the user response, physical examination data and the result of diagnostic tests performed. The physician associated with the physician system 472 selects at least one diagnosis as the diagnosed illness from the list of probable diagnosis.

The diagnosed illness (based on physician's selection on the physician system 472) is provided to the knowledge base 474. The knowledge base 474 compares the medical history data and the diagnosed illness with the plurality of patterns in the knowledge base 474 to generate a list of treatment plans for the diagnosed illness based on historical data available in the knowledge base 474. The physician can select at least one treatment plan on the physician system 472 from the list of treatment plans suggested by the knowledge base 474. The knowledge base 474 provides additional solutions based on the treatment plan selected by the physician. For example, the knowledge base 474 provides answers to frequently asked questions of patients such as side effects of the treatment, precautions and treatment management.

The architecture 470 also includes the server 486 (an example of the server 140 of FIG. 1) as a main component for managing the CAHTS and storing electronic medical record corresponding to the plurality of patients. The physician can retrieve medical history data corresponding to a patient over time by accessing the EMR. Alternatively, the medical history data is classified, distributed and stored in the databases 478, 480, 482, 484.

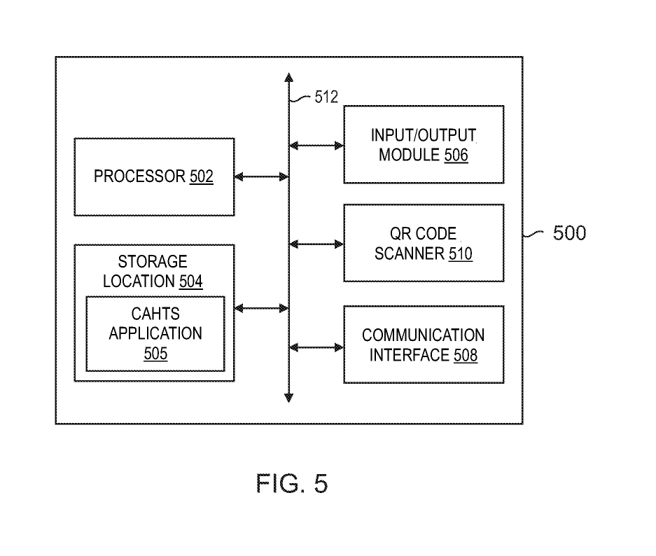

FIG. 5 is an example of a processing device 500, in accordance with an example embodiment of the present disclosure. The device 500 includes at least one processor such as a processor 502 and at least one memory such as a storage location 504. The device 500 also includes an I/O module 506 and a communication interface 508. The device 500 can be embodied in the server 140 (or the server 486), or can be example of any device used for performing functions of the CAHTS system for example any device employing the patient CAHTS 130 or the physician CAHTS 106.

Although the device 500 is depicted to include only one processor 502, the device 500 may include more number of processors therein. In an embodiment, the storage location 504 is capable of storing CAHTS application instructions 505, where the application instructions 505 are machine executable instructions associated with providing acquiring and storing patient history of users. Further, the processor 502 is capable of executing the stored platform instructions. In an embodiment, the processor 502 may be embodied as a multi-core processor, a single core processor, or a combination of one or more multi-core processors and one or more single core processors. For example, the processor 502 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 502 may be configured to execute hard-coded functionality. In an embodiment, the processor 502 is embodied as an executor of software instructions, wherein the instructions may specifically configure the processor 502 to perform the algorithms and/or operations described herein when the instructions are executed.

The storage locations 504 may be embodied as one or more volatile memory devices, one or more non-volatile memory devices, and/or a combination of one or more volatile memory devices and non-volatile memory devices. For example, the storage location 504 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

The device 500 also includes an input/output module 506 (hereinafter referred to as ‘I/O module 506’) for providing an output and/or receiving an input. The I/O module 506 is configured to be in communication with the processor 502 and the storage location 504. Examples of the I/O module 506 include, but are not limited to, an input interface and/or an output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, the processor 502 may include I/O circuitry configured to control at least some functions of one or more elements of the I/O module 506, such as, for example, a speaker, a microphone, a display, and/or the like. The processor 502 and/or the I/O circuitry may be configured to control one or more functions of the one or more elements of the I/O module 506 through computer program instructions, for example, software and/or firmware, stored on a memory, for example, the storage location 504, and/or the like, accessible to the processor 502.

In an embodiment, the I/O module 506 may be configured to provide a user interface (UI) configured to enable users to provide responses to the questionnaire generated by CAHTS (e.g., CAHTS 130). Also, the I/O module 506 may be configured to provide feedback/recommendations/updates/alerts (e.g., email notifications, SMS alerts, etc.) related to any event. The remote devices may be any device on the network devices in the user's network.

The communication interface 508 may enable the device 500 to communicate with other devices such as devices 116, 118, 120, 122 and the server 140. The communication interface 508 may be configured to communicate to various types of networks such as the network 102 as explained with reference to FIG. 1. In an embodiment, the device 500 includes a QR code scanner 510 that is configured to decode a QR code generated in response to the medical history data obtained from the user in a structured format via a questionnaire. The QR code can either be generated by an application or software in a user device associated with the user (e.g., device 120 as shown in FIG. 1) or by CAHTS, such as, the patient CAHTS 130 (shown in FIG. 1). The decoded QR code corresponds to the medical history data of a patient (patient's medical history) as recorded by user (e.g., user 112) in an associated user device.

In an embodiment, various components of the device 500, such as the processor 502, the storage location 504, the I/O module 506, the communication interface 508 and the QR code scanner 510 are configured to communicate with each other via or through a centralized circuit system 512. The centralized circuit system 512 may be various devices configured to, among other things, provide or enable communication between the components (502-510) of the device 500. In certain embodiments, the centralized circuit system 512 may be a central printed circuit board (PCB) such as a motherboard, a main board, a system board, or a logic board. The centralized circuit system 512 may also, or alternatively, include other printed circuit assemblies (PCAs) or communication channel media.

It is understood that the device 500 as illustrated and hereinafter described is merely illustrative of a system that could benefit from embodiments of the invention and, therefore, should not be taken to limit the scope of the invention. It is noted that the device 500 may include fewer or more components than those depicted in FIG. 5. In an embodiment, the device 500 may be implemented as a platform including a mix of existing open systems, proprietary systems and third party systems. In another embodiment, the device 500 may be implemented completely as a platform including a set of software layers on top of existing hardware systems. In an embodiment, one or more components of the device 500 may be deployed in a web server. In another embodiment, the device 500 may be a standalone component in a remote machine connected to a communication network (such as the network 102 explained with reference to FIG. 1) and capable of executing a set of instructions (sequential and/or otherwise). Moreover, the device 500 may be implemented as a centralized system, or, alternatively, the various components of the device 500 may be deployed in a distributed manner while being operatively coupled to each other. In an embodiment, one or more functionalities of the device 500 may also be embodied as a client within devices, such as users' devices. In another embodiment, the device 500 may be a central system that is shared by or accessible to each of such devices.

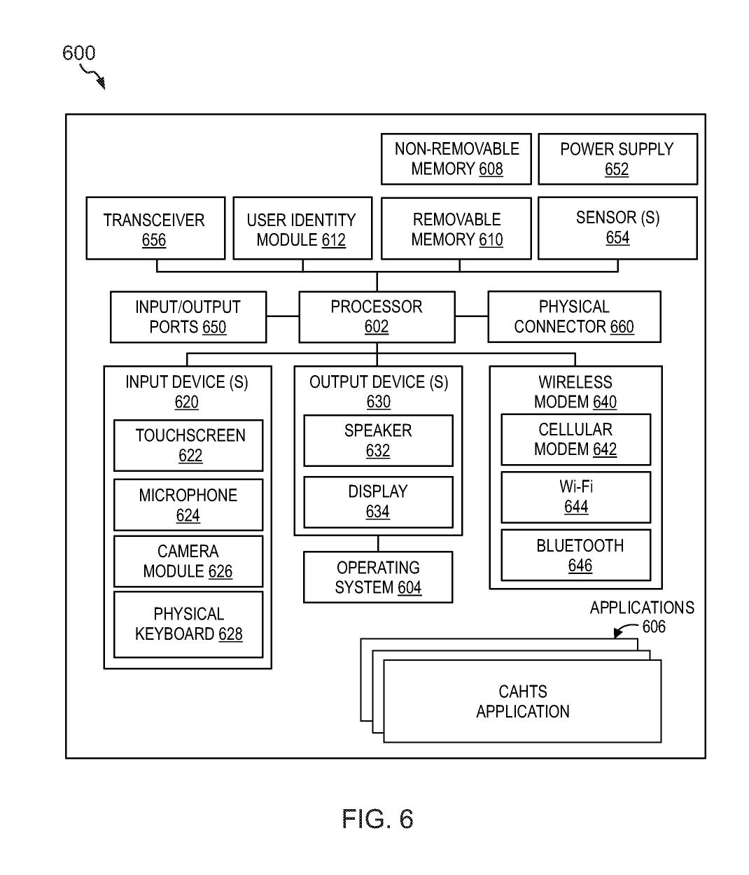

FIG. 6 is a schematic block diagram of a user device 600 (e.g., user devices 118, 120, 122 shown in FIG. 1) that is capable of implementing embodiments for providing user responses to a questionnaire and generate a corresponding QR code. It should be understood that the user device 600 as illustrated and hereinafter described is merely illustrative of one type of device and should not be taken to limit the scope of the embodiments. As such, it should be appreciated that at least some of the components described below in connection with the user device 600 may be optional and thus in an example embodiment may include more, less or different components than those described in connection with the example embodiment of the FIG. 6. As such, among other examples, the user device 600 could be any of a mobile electronic device, for example, personal digital assistants (PDAs), mobile televisions, gaming devices, cellular phones, tablet computers, laptops, mobile computers, cameras, mobile digital assistants, or any combination of the aforementioned, and other types of communication or multimedia devices.

The illustrated user device 600 includes a controller or a processor 602 (e.g., a signal processor, microprocessor, ASIC, or other control and processing logic circuitry) for performing such tasks as signal coding, data processing, image processing, input/output processing, power control, and/or other functions. An operating system 604 controls the allocation and usage of the components of the user device 600 and support for one or more applications programs, such as an application for recording user responses to a questionnaire on the user device 600 and generating a QR code corresponding to the user responses, or the application could be a mobile based application or a SIM based application, that implements one or more of the innovative features described herein. In addition to the application for recording user responses, the application programs can include common mobile computing applications (e.g., telephony applications, E-mail applications, calendars, contact managers, web browsers, messaging applications) or any other computing application.

The illustrated user device 600 includes one or more memory components, for example, a non-removable memory 608 and/or removable memory 610. The non-removable memory 608 can include RAM, ROM, flash memory, a hard disk, or other well-known memory storage technologies. The removable memory 610 can include flash memory, smart cards, or a Subscriber Identity Module (SIM). The one or more memory components can be used for storing data and/or code for running the operating system 604 and the applications 606. Example of data can include web pages, text, images, sound files, image data, video data, or other data sets to be sent to and/or received from one or more network servers or other devices via one or more wired or wireless networks. The user device 600 may further include a user identity module (UIM) 612. The UIM 612 may be a memory device having a processor built in. The UIM 612 may include, for example, a subscriber identity module (SIM), a universal integrated circuit card (UICC), a universal subscriber identity module (USIM), a removable user identity module (R-UIM), or any other smart card. The UIM 612 typically stores information elements related to a mobile subscriber. The UIM 612 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 600 can support one or more input devices 620 and one or more output devices 630. Examples of the input devices 620 may include, but are not limited to, a touchscreen 622 (e.g., capable of capturing finger tap inputs, finger gesture inputs, multi-finger tap inputs, multi-finger gesture inputs, or keystroke inputs from a virtual keyboard or keypad), a microphone 624 (e.g., capable of capturing voice input), a camera module 626 (e.g., capable of capturing still picture images and/or video images) and a physical keyboard 628. Examples of the output devices 630 may include, but are not limited to a speaker 632 and a display 634. Other possible output devices (not shown in the FIG. 6) can include piezoelectric or other haptic output devices. Some devices can serve more than one input/output function. For example, the touchscreen 622 and the display 634 can be combined into a single input/output device.

A wireless modem 640 can be coupled to one or more antennas (not shown in the FIG. 6) and can support two-way communications between the processor 602 and external devices, as is well understood in the art. The wireless modem 640 is shown generically and can include, for example, a cellular modem 642 for communicating at long range with the mobile communication network, a Wi-Fi compatible modem 644 for communicating at short range with an external Bluetooth-equipped device or a local wireless data network or router, and/or a Bluetooth-compatible modem 646. The wireless modem 640 is typically configured for communication with one or more cellular networks, such as a GSM network for data and voice communications within a single cellular network, between cellular networks, or between the user device 600 and a public switched telephone network (PSTN).

The user device 600 can further include one or more input/output ports 650, a power supply 652, one or more sensors 654 for example, an accelerometer, a gyroscope, a compass, or an infrared proximity sensor for detecting the orientation or motion of the user device 600, a transceiver 656 (for wirelessly transmitting analog or digital signals) and/or a physical connector 660, which can be a USB port, IEEE 1394 (FireWire) port, and/or RS-232 port. The illustrated components are not required or all-inclusive, as any of the components shown can be deleted and other components can be added.

With the application (see 606) and/or other software or hardware components, the user device 600 can implement the technologies described herein. For example, the processor 602 can facilitate recording of user responses to a questionnaire on the user device 600, process the user responses to generate medical history data and generate a QR code corresponding to the medical history data of the user that is transmitted securely over a network to a physician system (e.g., CAHTS 106).

Although the user device 600 is illustrated in FIG. 6 in form of a smartphone, but more particularly, the techniques and solutions described herein can be implemented with connected devices having other screen capabilities and device form factors, such as a tablet computer, a smart device, and the like.

Various embodiments disclosed herein provide numerous advantages. The systems and methods disclosed herein enable acquisition and processing of patient's medical history. The patient may provide medical history associated with the patient on the CAHTS in waiting room of a hospital, thus saving waiting time to meet a physician. Thus computer assisted method of acquiring patient's medical history is simple and does not require extra time. The medical data collected by CAHTS is useful and assists the physician in diagnosing illness associated with the patient. Moreover, the CAHTS conducts comprehensive history taking, which includes ROC or negative symptoms for differential diagnosis. The CAHTS does not include medical questions such as treatment or medicine name but CAHTS is based on symptoms that is familiar by the patients and assists the physician on possible diagnosis, treatment plan and side effects associated with treatment plan. Moreover, the medical data associated with the patient may be classified and stored in database for studying possible trends among population. Further, the medical data associated with the patient in the CAHTS may be transformed into natural languages by a processor. Furthermore, the physician may use the medical data associated with the natural language to store in EMR. Moreover, patients with reading difficulty may choose to hear the questions in the questionnaire and respond to the questionnaire. The questionnaire may include multiple choice questions based on symptoms for which the patient may chose an option from an available list. Furthermore, the software for acquiring patient's medical history can be acquired on personal devices, for example, mobile phone. The responses of the patient that correspond to patient's history as recorded on the personal device of the patient can be transformed into QR code for transmission to the physician CAHTS over a network. The use of QR code for encoding patient's medical history provides data security. The QR code is a simple and efficient method for data security. Further, the hospital requires a QR code scanner to acquire the patient's medical history from the personal device associated with the patient.

Some components of the CAHTS disclosed in various embodiments may be implemented in software, hardware, application logic or a combination of software, hardware and application logic. The software, application logic and/or hardware may reside on one or more memory locations, one or more processors, an electronic device or, a computer program product. In an embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, as described and depicted in FIGS. 1 and 6. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A method for acquisition and processing of medical history, the method comprising:
facilitating, by a processor, receipt of medical history data corresponding to a patient, the medical history data obtained in a structured format comprising information corresponding to health condition of the patient;
providing, by the processor, a quick response code corresponding to the medical history data of the patient to a physician system;
facilitating, by the processor, receipt of physician observation data from the physician system in response to the quick response code received at the physician system, wherein the physician observation data is appended to the medical history data;
transforming, by the processor, the medical history data and the physician observation data of the patient into a natural language format; and
storing, by the processor, the medical history data and the physician observation data in the natural language format in an electronic medical record.

2. The method as claimed in claim 1, further comprising:
generating, by the processor, a list of probable diagnosis on the physician system, wherein the list of probable diagnosis is generated based on the medical history data and the physician observation data;
facilitating, by the processor, selection of at least one diagnosis as a diagnosed illness from the list of probable diagnosis on the physician system;
generating, by the processor, a list of treatment plans on the physician system based on the diagnosed illness; and
facilitating, by the processor, selection of at least one treatment plan from the list of treatment plans for the diagnosed illness on the physician system.

3. The method as claimed in claim 2, wherein the physician observation data is at least one of a physical examination data, a diagnostic test data, the diagnosed illness and the at least one treatment plan for the diagnosed illness.

4. The method as claimed in claim 2, further comprising:
analyzing, by the processor, the medical history data corresponding to the patient, wherein analysis of the medical history data is used to generate the list of probable diagnosis; and
classifying, by the processor, the medical history data corresponding to the patient, wherein the classification of the medical history data is based on the diagnosed illness and the at least one treatment plan.

5. The method as claimed in claim 2, further comprising:
facilitating, by the processor, access of an application installed on a user device, wherein the application is configured to acquire the medical history data of the patient; and
generating, by the processor, a questionnaire in the application on the user device for acquiring the medical history data of the patient.

6. The method as claimed in claim 5, wherein the questionnaire comprises questions for symptom diagnosis or negative symptoms for differential diagnosis.

7. The method as claimed in claim 5, wherein the questionnaire is generated inform of audio on the user device and the user response is received inform of audio input.

8. The method as claimed in claim 5, further comprising:
acquiring, by the processor, a feedback and one or more symptoms of the at least one treatment plan from the patient;
analyzing, by the processor, health condition of the patient based on the feedback, the one or more symptoms and the at least one treatment plan; and
updating, by the processor, at least one of the list of probable diagnosis and the list of treatment plans in a database based on the analyzed health condition of the patient.

9. The method as claimed in claim 1, further comprising storing patient personal information in the electronic medical record.

10. The method as claimed in claim 1, further comprising:
storing, by the processor, the medical history data of the patient in a database without patient personal information.

11. A system comprising:
a memory to store instructions; and
a processor coupled to the memory and configured to execute the stored instructions to cause the system to at least perform:
facilitate receipt of medical history data corresponding to a patient, the medical history data obtained in a structured format comprising information corresponding to health condition of the patient;
provide a quick response code corresponding to the medical history data of the patient to a physician system;
facilitate receipt of physician observation data from the physician system in response to the quick response code received at the physician system, wherein the physician observation data is appended to the medical history data;
transform the medical history data of the patient into a natural language format; and
store the medical history data of the patient in the natural language format in an electronic medical record.

12. The system as claimed in claim 11, wherein the system is further caused to perform:
generate a list of probable diagnosis on the physician system, wherein the list of probable diagnosis is generated based on the medical history data and the physician observation data;
facilitate selection of at least one diagnosis as a diagnosed illness from the list of probable diagnosis on the physician system;
generate a list of treatment plans on the physician system based on the diagnosed illness; and
facilitate selection of at least one treatment plan from the list of treatment plans for the diagnosed illness on the physician system.

13. The system as claimed in claim 12, wherein the system is further caused to perform:
analyze the medical history data corresponding to the patient, wherein analysis of the medical history data is used to generate the list of probable diagnosis; and
classify the medical history data corresponding to the patient, wherein the classification of the medical history data is based on the diagnosed illness and the at least one treatment plan.

14. The system as claimed in claim 12, wherein the physician observation data is at least one of a physical examination data, a diagnostic test data, the diagnosed illness and the at least one treatment plan for the diagnosed illness.

15. The system as claimed in claim 11, wherein the system is further caused to perform:
facilitate access of an application installed on a user device, wherein the application is configured to acquire the medical history data of the patient; and
generate a questionnaire in the application on the user device for acquiring the medical history data of the patient.

16. The system as claimed in claim 15, wherein the questionnaire comprises questions for symptom diagnosis or negative symptoms for differential diagnosis.

17. The system as claimed in claim 15, wherein the system is caused to playback of audio corresponding to the questionnaire and the patient provides user response in response to the questionnaire on a corresponding user device.

18. A computer assisted history tracking system (CAHTS) for acquisition and processing of medical history, comprising:
a patient CAHTS accessible to a user device, the patient CAHTS configured to:
present questionnaire to a user of the user device in structured format,
collect medical history data based on user's response to the questionnaire in the structured format, and
generate a quick response code corresponding to the medical history data;
a physician CAHTS accessible on a physician device, the physician CAHTS configured to:
receive the quick response code corresponding to the medical history data from the patient CAHTS,
append the physician observation data to the medical history data obtained from the quick response code; and
a server configured to:
receive the medical history data appended with the physician observation data; and
transform the medical history data appended with the physician observation data into a natural language format; and
store the medical history data appended with the physician observation data in the natural language format in an electronic medical record.

19. The CAHTS as claimed in claim 18, wherein the server is configured to store the medical history data of the patient in a database without the patient personal information.

20. The CAHTS as claimed in claim 18, wherein the server is further configured to:
generate a list of probable diagnosis on the physician system, wherein the list of probable diagnosis is generated based on the medical history data and the physician observation data;
facilitate selection of at least one diagnosis as a diagnosed illness from the list of probable diagnosis on the physician system;
generate a list of treatment plans on the physician system based on the diagnosed illness; and
facilitate selection of at least one treatment plan from the list of treatment plans for the diagnosed illness on the physician system.
